(19) United States
(12) Patent Application Publication
(10) Pub. No.: US 2026/0213565 A1
(43) Pub. Date: Jul. 23, 2026

(54) BATTERY SYSTEM

(71) Applicant: TOYOTA JIDOSHA KABUSHIKI KAISHA, Toyota-shi (JP)

(72) Inventor: Masashi KOBAYASHI, Toyota-shi (JP)

(73) Assignee: TOYOTA JIDOSHA KABUSHIKI KAISHA, Toyota-shi (JP)

(21) Appl. No.: 19/404,458

(22) Filed: Dec. 1, 2025

(30) Foreign Application Priority Data
Jan. 22, 2025 (JP) 2025-008932

(51) Int. Cl. H02J 7/90; B60L 53/62; B60L 55/00; B60L 58/26; H01M 10/613; H01M 10/625; H01M 10/633

(52) U.S. Cl. CPC H02J 7/977; H01M 10/613; H01M 10/625; H01M 10/633; B60L 53/62; B60L 55/00; B60L 58/26; B60L 2240/545; H01M 2220/20

(57) ABSTRACT

An ECU executes a process including: acquiring a limitation history when conditions for executing transfer control are satisfied; when current limitation was performed in the previous transfer control, performing cooling control when battery temperature is greater than a start temperature; performing current limitation when the battery temperature is greater than a limit temperature; ending the cooling control when conditions for ending the cooling control are satisfied; and storing the limitation history.

### CROSS-REFERENCE TO RELATED APPLICATION

This application claims priority to Japanese Patent Application No. 2025-008932 filed on Jan. 22, 2025. The disclosure of the above-identified application, including the specification, drawings, and claims, is incorporated by reference herein in its entirety.

### BACKGROUND

### 1. Technical Field

The present disclosure relates to battery systems.

### 2. Description of Related Art

Japanese Unexamined Patent Application Publication No. 2001-313092 (JP 2001-313092 A) discloses a technique in which a cooling fan is driven when the deviation between the estimated temperature of a secondary battery and the actual battery temperature is greater than a threshold, and an abnormality signal is output when the deviation does not become less than or equal to the threshold even after the cooling fan is driven.

### SUMMARY

In a case where the temperature of the secondary battery rises even after cooling of a secondary battery has been started during power transfer, it is conceivable to limit the transfer current. However, if the transfer current is limited, the time required for power transfer may become prolonged.

The present disclosure has been made to address the above issue, and an object thereof is to provide a battery system that cools a secondary battery such that the transfer current is not limited during power transfer.

A battery system according to one aspect of the present disclosure includes: a secondary battery; a transfer system configured to perform power transfer to and from the secondary battery; an adjustment device configured to adjust the temperature of the secondary battery; and a control device configured to control the adjustment device so as to cool the secondary battery when the temperature of the secondary battery exceeds a first threshold during transfer control of electric power. The control device is configured to limit transfer power transferred between the secondary battery and the transfer system when the temperature of the secondary battery exceeds a second threshold that is greater than the first threshold. The control device is configured to, when the transfer power is limited in previous transfer control, set the first threshold in current transfer control to a value smaller than the first threshold in the previous transfer control.

With this configuration, in the current transfer control, cooling of the secondary battery using the adjustment device is performed earlier than in the previous transfer control. Accordingly, it is possible to reduce the likelihood of the temperature of the secondary battery exceeding the second threshold. As a result, the likelihood of the transfer power being limited can be reduced, and the time required for power transfer is less likely to become prolonged.

In one embodiment, the control device is configured to, when the secondary battery is in a degraded condition, increase an amount by which the first threshold is lowered, compared to when the secondary battery is in a new condition.

The internal resistance rises and heat generation increases when the secondary battery is in a degraded condition. Therefore, by increasing the amount by which the first threshold is lowered compared to when the secondary battery is in a new condition, it is possible to reduce the likelihood of the temperature of the secondary battery exceeding the second threshold.

In another embodiment, the control device is configured to set the first threshold in the current transfer control to a value smaller than the first threshold in the previous transfer control by at least an amount by which the temperature of the secondary battery exceeded the second threshold in the previous transfer control.

With this configuration, the first threshold in the current transfer control is set to a value smaller than the first threshold in the previous transfer control by at least the amount by which the temperature of the secondary battery exceeded the second threshold in the previous transfer control. It is therefore possible to reliably reduce the likelihood of the temperature of the secondary battery exceeding the second threshold.

In still another embodiment, the control device is configured to, when the temperature of the secondary battery falls below the second threshold while the transfer power is being limited, lift limitation of the transfer power.

With this configuration, since the limitation is lifted, the time required for power transfer is less likely to become prolonged.

The present disclosure can thus provide a battery system that cools a secondary battery such that transfer current is not limited during power transfer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of the configuration of a power transfer system;

FIG. 2 shows graphs illustrating an example of a history of changes in battery temperature during power transfer for a battery in a new condition and in a degraded condition, respectively;

FIG. 3 is a flowchart illustrating an example of a process executed by an electronic control unit (ECU);

FIG. 4 shows graphs illustrating an example of changes in battery temperature in the Nth transfer control and the (N+1)th transfer control, respectively; and

FIG. 5 is a graph illustrating an example of the relationship between the start temperature and the degree of degradation.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

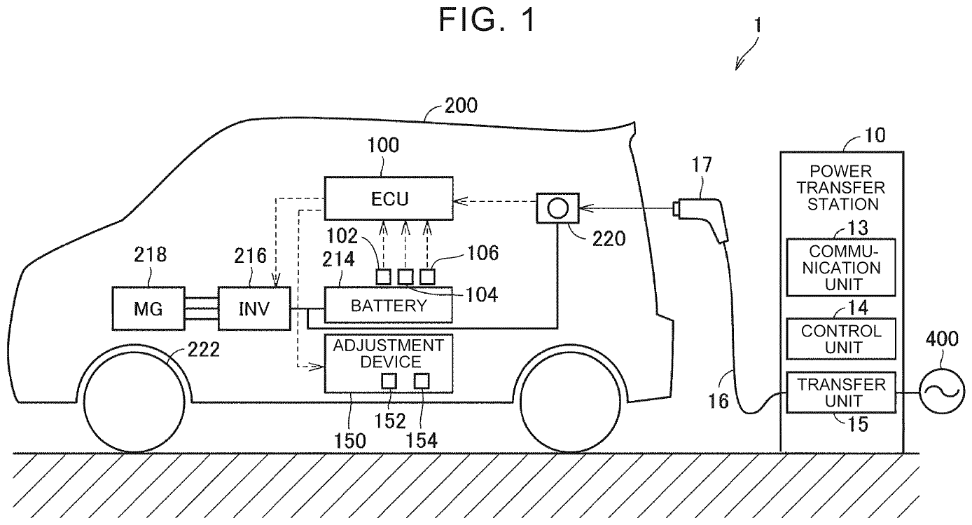

An example of the configuration of a battery system 1 according to the present embodiment will now be described. FIG. 1 shows an example of the configuration of the battery system 1. As shown in FIG. 1, the battery system 1 includes a vehicle 200 and a power transfer station 10 that is located outside the vehicle 200. The vehicle 200 may be any vehicle that can transfer electric power to and from an external facility, and may be, for example, an electrified vehicle such as a battery electric vehicle or a plug-in hybrid electric vehicle.

The vehicle 200 includes an electronic control unit (ECU) 100 that is a control device, an adjustment device 150, a battery 214, an inverter 216, a motor generator (MG) 218, and an inlet 220.

The battery 214 may be any rechargeable energy storage device, and may be a secondary battery such as a nickel metal hydride battery or a lithium-ion battery with a liquid or solid electrolyte. Alternatively, a large-capacity capacitor may be used instead of the battery 214.

The inverter 216 is configured to convert direct current power from the battery 214 and alternating current power from the MG 218 bidirectionally in accordance with control signals from the ECU 100.

The MG 218 is a drive source that drives drive wheels 222 of the vehicle 200, and is constituted by, for example, a three-phase alternating current rotating electrical machine. The MG 218 functions both as an electric motor that causes the vehicle 200 to travel using power from the battery 214, and as a generator that generates power (e.g., regenerative power) for charging the battery 214.

The inlet 220 has a shape that allows a connector 17 of the power transfer station 10 to be attached thereto. The inlet 220 is electrically connected to the battery 214.

A voltage sensor 102 that acquires the voltage of the battery 214, a current sensor 104 that acquires the current of the battery 214, and a temperature sensor 106 that acquires the temperature of the battery 214 are connected to the ECU 100. The ECU 100 includes a central processing unit (CPU) and a memory (neither of which is shown). Based on signals received from the sensors and information such as maps and programs stored in the memory, the ECU 100 controls the various devices such that the vehicle 200 achieves a desired state.

The ECU 100 has a function to continuously calculate the state of charge (SOC)

of the battery 214 based on the detection values from the voltage sensor 102, the current sensor 104, and the temperature sensor 106. As a method for calculating the SOC, various known methods may be employed, such as a method based on current integration (coulomb counting) or a method based on estimation of open-circuit voltage (OCV). The ECU 100 is configured to communicate with a communication unit 13 of the power transfer station 10 described later.

The adjustment device 150 is configured to regulate the temperature of the battery 214 in accordance with control signals from the ECU 100. The adjustment device 150 includes a heating device 152 that heats the battery 214 and a cooling device 154 that cools the battery 214. The heating device 152 may be constituted by, for example, an electric heater (not shown). The cooling device 154 may be constituted by, for example, a cooling fan (not shown). The cooling device 154 may be constituted by, for example, a radiator capable of heat exchange, a medium (e.g., coolant or gas), a pump that circulates the medium, and a cooling passage through which the medium flows.

When raising the temperature of the battery 214, the ECU 100 operates the heating device 152 while keeping the cooling device 154 in a stopped state. For example, the ECU 100 operates the heating device 152 when the temperature of the battery 214 is lower than a predetermined temperature range that includes a target temperature.

When lowering the temperature of the battery 214, the ECU 100 operates the cooling device 154 while keeping the heating device 152 in a stopped state. Each of the heating device 152 and the cooling device 154 is configured to operate using either or both of power supplied (transferred) from the power transfer station 10 to the inlet 220 (i.e., power from an external power source) and power supplied (transferred) from the battery 214.

The power transfer station 10 is an electrical device that includes the communication unit 13, a control unit 14, a transfer unit 15, a cable 16, and the connector 17. The power transfer station 10 may, for example, transfer power from a grid power source 400 to the battery 214 of the vehicle 200 to charge the battery 214, or transfer power from the battery 214 to the grid power source 400 to discharge the battery 214.

When the connector 17 is connected to the inlet 220 of the vehicle 200, the communication unit 13 performs wired communication, such as power line communication, control area network (CAN) communication, or local area network (LAN) communication, with the ECU 100 of the vehicle 200 via the cable 16. Communication may be performed by wireless communication in accordance with various standards (e.g., Wi-Fi).

The control unit 14 controls the operation of the transfer unit 15 (e.g., transfer voltage or transfer current) based on control signals received from the ECU 100. The control unit 14 includes a CPU and a memory (neither or which is shown). The control unit 14 controls the transfer unit 15 based on information received from the vehicle 200 via the communication unit 13 and information such as maps and programs stored in the memory.

The transfer unit 15 converts alternating current power from the grid power source 400 into direct current power or converts direct current power from the battery 214 into alternating current power, in accordance with control signals from the control unit 14. One end of the cable 16 is connected to the transfer unit 15. The connector 17 is connected to the other end of the cable 16.

The connector 17 has a shape that allows it to be attached to the inlet 220. When the connector 17 is attached to the inlet 220, either a first state or a second state is established in accordance with a control signal received by the control unit 14 from the ECU 100. The first state is a state in which direct current power from the transfer unit 15 can be supplied to the battery 214. The second state is a state in which alternating current power from the transfer unit 15 can be supplied to the grid power source 400. For example, when external charging is requested, the ECU 100 transmits a control signal to the control unit 14 such that the first state is established when the connector 17 is attached to the inlet 220. For example, when discharging to the power transfer station 10 is requested, the ECU 100 transmits a control signal to the control unit 14 such that the second state is established when the connector 17 is attached to the inlet 220.

In the present embodiment, the “secondary battery” is constituted by the battery 214, the “transfer system” is constituted by the inlet 220 and the power line connecting the battery 214 and the inlet 220, the “control device” is constituted by the ECU 100, and the “adjustment device” is constituted by the adjustment device 150.

For example, when the SOC of the battery 214 is lower than a threshold, the ECU 100 requests fast charging. In addition, when power transfer (hereinafter referred to as “vehicle-to-home (V2H)”) is performed between the vehicle 200 and a facility (e.g., a home) where the power transfer station 10 is installed, the ECU 100 requests discharging when the battery 214 is to be used as the power source for the facility, and requests charging when surplus power is to be stored in the battery 214.

During power transfer using the battery 214, the ECU 100 calculates the SOC of the battery 214 and the temperature of the battery 214 using the detection values from the voltage sensor 102, the current sensor 104, and the temperature sensor 106. When the temperature of the battery 214 exceeds a first threshold during power transfer using the battery 214, the ECU 100 operates the cooling device 154 to cool the battery 214. In a case where the temperature of the battery 214 exceeds a second threshold (greater than the first threshold) even after the cooling device 154 has been operated, it is conceivable for the ECU 100 to transmit a control command to the power transfer station 10 to limit the transfer current. However, when the transfer current is limited, the time required for power transfer may become prolonged. For example, in the case of charging the battery 214, the time it takes for the battery 214 to reach a fully charged state may become longer.

Such an issue becomes particularly pronounced when the battery 214 is in a degraded condition than when it is in a new condition, because internal resistance rises and heat generation increases.

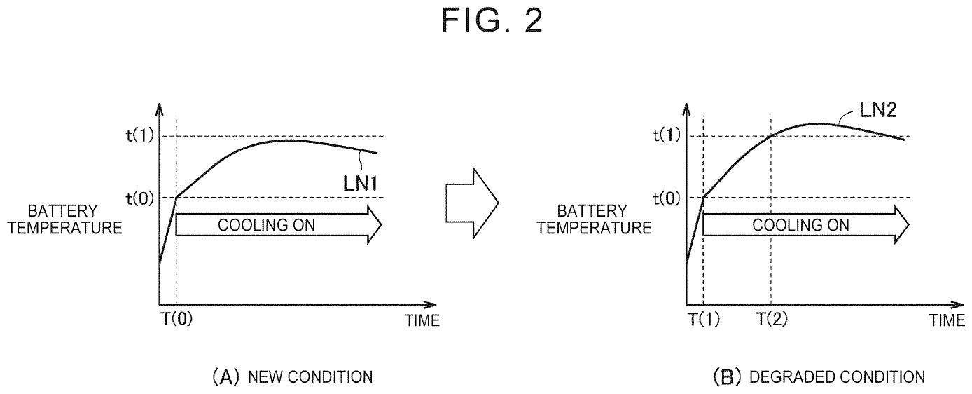

FIG. 2 shows graphs illustrating an example of a history of changes in battery temperature during power transfer for the battery 214 in a new condition and in a degraded condition, respectively. In both graphs (A), (B) of FIG. 2, the vertical axis represents battery temperature. In both graphs (A), (B) of FIG. 2, the horizontal axis represents time. LN1 in graph (A) of FIG. 2 illustrates an example of a history of changes in battery temperature of the battery 214 in a new condition. LN2 in graph (B) of FIG. 2 illustrates an example of a history of changes in battery temperature of the battery 214 in a degraded condition.

As shown by LN1 in graph (A) of FIG. 2, when the battery 214 in a new condition is being charged and the cooling device 154 is in a non-operating state, the battery temperature increases in proportion to the passage of time.

When the temperature of the battery 214 exceeds a threshold t(0) at time T(0), the cooling device 154 enters an operating state. As a result, the amount of heat dissipation increases and the rate of increase in battery temperature per unit time becomes more gradual (decreases). Therefore, after the cooling device 154 has entered the operating state, the temperature of the battery 214 changes without exceeding a threshold t(1) for limiting the charging current, that is, without the charging current being limited.

On the other hand, as shown by LN2 in graph (B) of FIG. 2, when the battery 214 in a degraded condition is being charged and the cooling device 154 is in the non-operating state, the battery temperature increases at a higher rate per unit time than when the battery 214 is in a new condition, due to an increase in heat generation caused by a rise in internal resistance.

When the temperature of the battery 214 exceeds the threshold t(0) at time T(1), the cooling device 154 enters the operating state. As a result, the rate of increase in battery temperature per unit time becomes more gradual. However, because heat generation of the battery 214 has increased, the battery temperature rises at a steeper rate of change than when the battery 214 is in a new condition. Accordingly, at time T(2) after the cooling device 154 has entered the operating state, the battery temperature exceeds the threshold t(1). When the battery temperature exceeds the threshold t(1) and the charging current becomes limited, the amount of heat generated in the battery 214 decreases. Therefore, the rate of increase in battery temperature per unit time becomes more gradual. When the battery temperature falls below the threshold t(1) thereafter, the limitation on the charging current is lifted.

As described above, when the battery 214 is in a degraded condition, the battery temperature is more likely to exceed the threshold t(1) than when the battery 214 is in a new condition, and the transfer current is more likely to be limited. As a result, the time required for power transfer may become prolonged.

Accordingly, in the present embodiment, when the transfer power was limited in the previous transfer control, the ECU 100 sets the first threshold in the current transfer control to a value smaller than the first threshold in the previous transfer control.

In this way, when the battery temperature rises in the current transfer control, cooling of the battery 214 using the adjustment device 150 (specifically, the cooling device 154) is performed earlier than in the previous transfer control. Accordingly, it is possible to reduce the likelihood of the temperature of the battery 214 exceeding the second threshold. As a result, the likelihood of the transfer power being limited can be reduced, and the time required for power transfer is less likely to become prolonged.

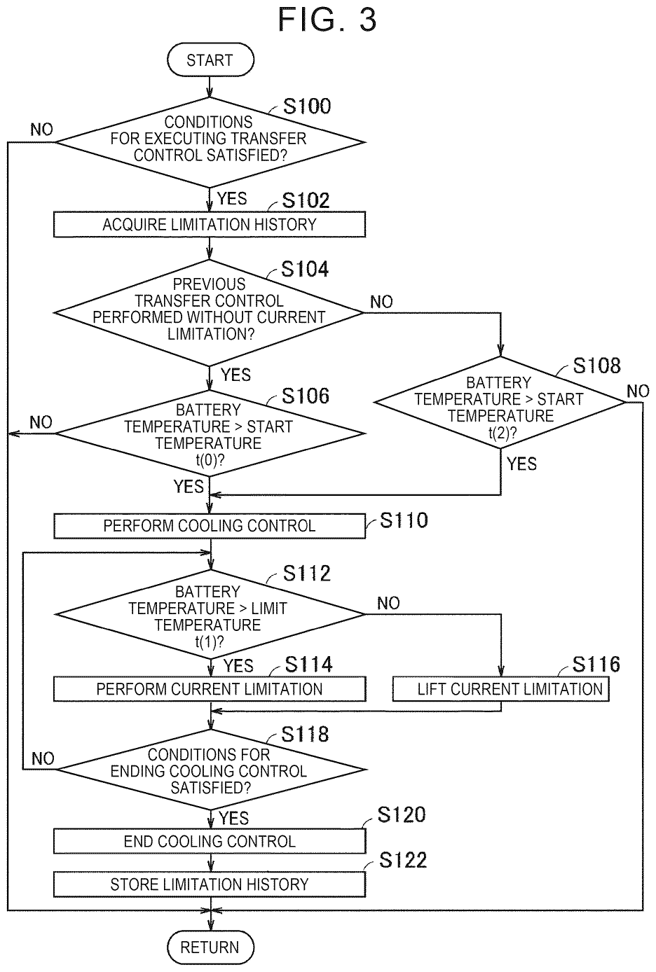

An example of a process executed by the ECU 100 will now be described with reference to FIG. 3. FIG. 3 is a flowchart illustrating an example of the process executed by the ECU 100.

In step 100 (hereinafter, “step” will be denoted as “S”), the ECU 100 determines whether the conditions for executing transfer control are satisfied. The conditions for executing transfer control may include, for example, a condition that the connector 17 is connected to the inlet 220 and a condition that a control command requesting charging or discharging is output from the ECU 100 to the power transfer station 10. When it is determined that the conditions for executing transfer control are satisfied (YES in S100), the process proceeds to S102.

In S102, the ECU 100 acquires a limitation history. The limitation history includes information indicating whether the transfer current was limited in the previous transfer control. The limitation history is stored in the memory of the ECU 100. The ECU 100 acquires the limitation history by reading it from the memory. The process then proceeds to S104.

In S104, the ECU 100 determines whether the previous transfer control was

performed without current limitation. Specifically, the ECU 100 determines, based on the acquired limitation history, whether the previous transfer control was performed without current limitation. When it is determined that the previous transfer control was performed without current limitation (YES in S104), the process proceeds to S106.

In S106, the ECU 100 determines whether the battery temperature is greater than a start temperature t(0) at which cooling is started. The start temperature t(0) is a threshold battery temperature for starting operation of the cooling device 154, and may be, for example, a predetermined value. The start temperature t(0) is adapted through experiments etc. such that, at least in a new condition, a limit temperature t(1) described later is not reached. The start temperature t(0) corresponds to the “first threshold,” and the limit temperature t(1) corresponds to the “second threshold.” The ECU 100 acquires the battery temperature using the temperature sensor 106. When it is determined that the battery temperature is greater than the start temperature t(0) (YES in S106), the process proceeds to S110. On the other hand, when it is determined that the previous transfer control was performed with current limitation (NO in S104), the process proceeds to S108.

In S108, the ECU 100 determines whether the battery temperature is greater than a start temperature t(2). The start temperature t(2) is also a threshold battery temperature for starting operation of the cooling device 154, and may be, for example, a predetermined value. The start temperature t(2) is at least lower than the start temperature t(0). The start temperature t(2) is adapted through experiments etc. such that, at least in a certain degraded condition, the limit temperature t(1) described later is not reached. When it is determined that the battery temperature is greater than the start temperature t(2) (YES in S108), the process proceeds to S110.

In S110, the ECU 100 executes cooling control. Specifically, the ECU 100 places the cooling device 154 in the operating state to cool the battery 214. The process then proceeds to S112.

In S112, the ECU 100 determines whether the battery temperature is greater than the limit temperature t(1). The limit temperature t(1) is a threshold temperature at which current limitation is started. For example, the limit temperature t(1) is adapted through experiments etc. When it is determined that the battery temperature is greater than the limit temperature t(1) (YES in S112), the process proceeds to S114.

In S114, the ECU 100 performs current limitation. The ECU 100 performs current limitation such that the magnitude of the transfer current during charging or discharging is controlled to be less than or equal to a predetermined value. The predetermined value may be, for example, any value at which the amount of heat dissipation in the battery 214 exceeds the amount of heat generation while the cooling device 154 is operating, and is adapted through experiments etc. The process then proceeds to S118. When it is determined that the battery temperature is less than or equal to the limit temperature t(1) (NO in S112), the process proceeds to S116.

In S116, the ECU 100 lifts the current limitation. When current limitation is not being performed, the ECU 100 maintains the state in which current limitation is not performed. The process then proceeds to S118.

In S118, the ECU 100 determines whether to end the cooling control. For example, the ECU 100 determines to end the cooling control when charging or discharging is completed, or when the battery temperature becomes less than or equal to a threshold temperature for ending the cooling control. When it is determined that the cooling control is to be ended (YES in S118), the process proceeds to S120. When it is determined that the cooling control is not to be ended (NO in S118), the process returns to S112.

In S120, the ECU 100 ends the cooling control. Specifically, the ECU 100 places the cooling device 154 in the non-operating state. The process then proceeds to S122.

In S122, the ECU 100 stores a control history. When current limitation was performed in the current transfer control, the ECU 100 stores, as the control history, information indicating that the transfer current was limited in the previous transfer control. When current limitation was not performed in the current transfer control, the ECU 100 stores, as the control history, information indicating that the transfer current was not limited in the previous transfer control. The process then ends. When it is determined that the conditions for executing transfer control are not satisfied (NO in S100), when it is determined that the battery temperature is less than or equal to the start temperature t(0) (NO in S106), or when it is determined that the battery temperature is less than or equal to the start temperature t(2) (NO in S108), the process also ends.

An example of the operation of the ECU 100 based on the above-described

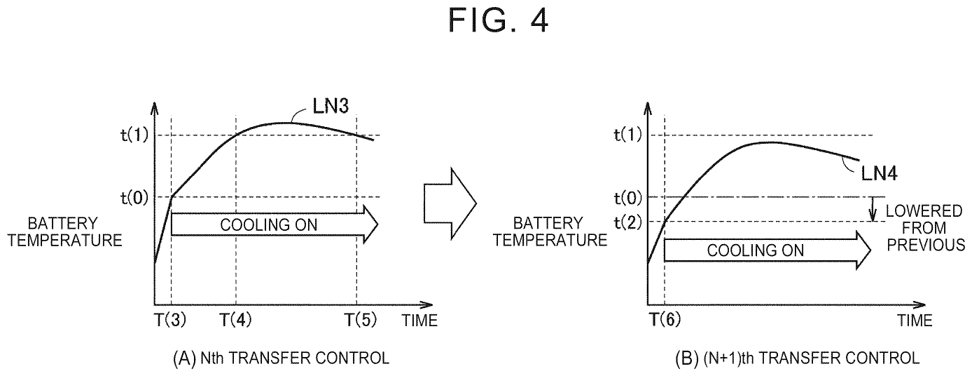

structure and flowchart will now be described with reference to FIG. 4. FIG. 4 shows graphs illustrating an example of changes in battery temperature in the Nth transfer control and the (N+1)th transfer control, respectively. In both graphs (A), (B) of FIG. 4, the vertical axis represents battery temperature. LN3 in graph (A) of FIG. 4 illustrates an example of a history of changes in battery temperature in the Nth transfer control. LN4 in graph (B) of FIG. 4 illustrates an example of a history of changes in battery temperature in the (N+1)th transfer control. It is assumed that no current limitation is performed up to the Nth transfer control.

As shown by LN3 in graph (A) of FIG. 4, in a case where the conditions for executing transfer control are satisfied (YES in S100) and charging of the battery 214 is started, when the cooling device 154 is in the non-operating state, the battery temperature increases in proportion to elapsed time until time T(3). When the Nth transfer control is started, the ECU 100 acquires the control history (S102). Since it is determined that the previous transfer control was performed without current limitation (YES in S104), it is determined whether the battery temperature is greater than the start temperature t(0) (S106).

When the battery temperature exceeds the start temperature t(0) at time T(3) (YES in S106), cooling control is executed (S110). When the cooling device 154 enters the operating state, the rate of increase in battery temperature becomes more gradual. However, when the battery 214 is in a degraded condition, internal resistance becomes higher than when it is in a new condition and heat generation increases. As a result, at time T(4), the battery temperature exceeds the limit temperature t(1). When the battery temperature exceeds the limit temperature t(1) (YES in S112), current limitation is performed (S114). While cooling control continues (NO in S118), heat generation is suppressed by performing current limitation. As a result, the battery temperature decreases when the amount of heat dissipation in the battery 214 exceeds the amount of heat generation. When the battery temperature becomes less than or equal to the limit temperature t(1) at time T(5) (NO in S112), the current limitation is lifted (S116). Because there is a period during which current limitation is performed, the time required for power transfer becomes prolonged. Thereafter, when the conditions for ending cooling control are satisfied such as when the transfer control ends (YES in S118), cooling control is ended (S120) and the limitation history is stored (S122).

On the other hand, as shown by LN4 in FIG. 4, in a case where the conditions for executing transfer control are again satisfied (YES in S100) and charging of the battery 214 is started next, when the cooling device 154 is in the non-operating state, the battery temperature increases in proportion to elapsed time until time T(6). When the (N+1)th transfer control is started, the ECU 100 acquires the control history (S102). Since it is determined that the previous transfer control was performed with current limitation (NO in S104), it is determined whether the battery temperature is greater than the start temperature t(2) (S108).

When the battery temperature exceeds the start temperature t(2) at time T(6) (YES in S108), cooling control is performed (S110). When the cooling device 154 enters the operating state, the rate of increase in battery temperature becomes more gradual. Furthermore, since the cooling device 154 enters the operating state at the lower start temperature t(2) that is lower than the start temperature t(0), the battery temperature changes without exceeding the limit temperature t(1) (NO in S112). As a result, transfer control continues without current limitation being performed (S116). The time required for power transfer is therefore less likely to become prolonged. Thereafter, when the conditions for ending cooling control are satisfied such as when the transfer control ends (YES in S118), cooling control is ended (S120), and information indicating that no current limitation was performed is stored as the limitation history (S122).

As described above, according to the battery system 1 of the present embodiment, in a case where current limitation was performed in the previous transfer control, whether to operate the cooling device 154 is determined using the start temperature t(2) that is lower than the start temperature t(0). Therefore, cooling of the battery 214 using the cooling device 154 can be performed earlier than in the previous transfer control. Accordingly, it is possible to reduce the likelihood of the temperature of the battery 214 exceeding the limit temperature t(1). As a result, the likelihood of the transfer power being limited can be reduced, and the time required for power transfer is less likely to become prolonged. It is therefore possible to provide a battery system that cools the secondary battery such that the transfer current is not limited during power transfer.

Furthermore, when the battery temperature becomes less than or equal to the limit temperature t(1) while current limitation is being performed, the ECU 100 lifts the current limitation. Accordingly, the time required for power transfer is less likely to become prolonged.

Next, modifications will be described. In the above embodiment, when it is determined that current limitation was performed in the previous transfer control, whether to operate the cooling device 154 is determined using the start temperature t(2). However, when the battery 214 is in a degraded condition, the amount by which the threshold of the start temperature is lowered may be made greater than it is in a new condition.

For example, the threshold of the start temperature may be set to decrease as the degradation progresses. The ECU 100 may, for example, calculate a full charge capacity of the battery 214 and calculate a degree of degradation (for example, capacity retention rate) by comparing the full charge capacity with its initial value. The ECU 100 may calculate a start temperature based on the degree of degradation using a map etc.

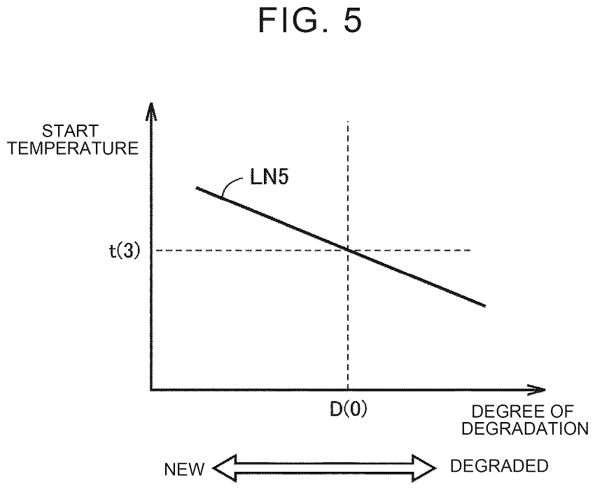

FIG. 5 is a graph illustrating an example of the relationship between the start temperature and the degree of degradation. The vertical axis in FIG. 5 represents the start temperature. The horizontal axis in FIG. 5 represents the degree of degradation. LN5 in FIG. 5 illustrates changes in the start temperature that are set in response to changes in the degree of degradation.

LN5 in FIG. 5 illustrates the relationship between the degree of degradation and the start temperature when they are linearly related. For example, when the degree of degradation is calculated to be D(0), the ECU 100 sets a start temperature t(3) according to the relationship shown by LN5 in FIG. 5.

The internal resistance rises and heat generation increases when the battery 214 is in a degraded condition. Therefore, by increasing the amount by which the start temperature is lowered compared to when the battery 214 is in a new condition, it is possible to reduce the likelihood of the battery temperature exceeding the limit temperature t(1). The relationship between the degree of degradation and the start temperature is not limited to a linear relationship, and may be a nonlinear relationship. This relationship may be any relationship as long as the start temperature decreases as the degree of degradation increases.

In addition, in the above embodiment, when it is determined that current limitation was performed in the previous transfer control, whether to operate the cooling device 154 is determined using the start temperature t(2). However, the ECU 100 may instead set the threshold of the start temperature in the current transfer control to a value smaller than the start temperature t(0) in the previous transfer control, for example, by at least the amount by which the battery temperature exceeded the limit temperature t(1) in the previous transfer control.

As described above, the threshold of the start temperature in the current transfer control is set to a value smaller than the start temperature t(0) in the previous transfer control by at least the amount by which the battery temperature exceeded the limit temperature t(1) in the previous transfer control. It is therefore possible to reliably reduce the likelihood of the battery temperature exceeding the limit temperature t(1).

Furthermore, in the above embodiment, when it is determined that current limitation was performed in the previous transfer control, whether to operate the cooling device 154 in the current transfer control is determined using, as a threshold, a start temperature lower than the start temperature used in the previous transfer control. However, in subsequent transfer controls, whether to operate the cooling device 154 may be determined using, as a threshold, a start temperature lower than the start temperature used in the previous transfer control. Alternatively, in a predetermined number of subsequent transfer controls, whether to operate the cooling device 154 may be determined using, as a threshold, a start temperature lower than the start temperature used in the previous transfer control.

All or part of the modifications described above may be combined as appropriate. The embodiments disclosed herein should be considered to be illustrative in all respects and not restrictive. The scope of the present disclosure is set forth in the claims rather than in the above description, and is intended to include all modifications within the meaning and scope equivalent to the claims.

What is claimed is:

1. A battery system comprising:
a secondary battery;
a transfer system configured to perform power transfer to and from the secondary battery;
an adjustment device configured to adjust a temperature of the secondary battery; and
a control device configured to control the adjustment device so as to cool the secondary battery when the temperature of the secondary battery exceeds a first threshold during transfer control of electric power,
wherein the control device is configured to
limit transfer power transferred between the secondary battery and the transfer system when the temperature of the secondary battery exceeds a second threshold that is greater than the first threshold, and
when the transfer power is limited in previous transfer control, set the first threshold in current transfer control to a value smaller than the first threshold in the previous transfer control.

2. The battery system according to claim 1, wherein the control device is configured to, when the secondary battery is in a degraded condition, increase an amount by which the first threshold is lowered, compared to when the secondary battery is in a new condition.

3. The battery system according to claim 1, wherein the control device is configured to set the first threshold in the current transfer control to a value smaller than the first threshold in the previous transfer control by at least an amount by which the temperature of the secondary battery exceeded the second threshold in the previous transfer control.

4. The battery system according to claim 1, wherein the control device is configured to, when the temperature of the secondary battery falls below the second threshold while the transfer power is being limited, lift limitation of the transfer power.
